(19) United States
(12) Patent Application Publication
(10) Pub. No.: US 2023/0004454 A1
(43) Pub. Date: Jan. 5, 2023

(54) DATA ABNORMALITY DETERMINATION APPARATUS AND INTERNAL STATE PREDICTION SYSTEM

(71) Applicant: HONDA MOTOR CO., LTD., Tokyo (JP)

(72) Inventors: Shunsuke KONISHI, Saitama (JP); Hidetoshi UTSUMI, Saitama (JP); Hodaka TSUGE, Saitama (JP); Seiichi KOKETSU, Saitama (JP)

(21) Appl. No.: 17/809,273

(22) Filed: Jun. 28, 2022

(30) Foreign Application Priority Data
Jun. 30, 2021 (JP) 2021-109172

(51) Int. Cl. G06F 11/00; G06N 7/00

(52) U.S. Cl. CPC G06F 11/006; G06N 7/005

(57) ABSTRACT

A data abnormality determination apparatus 1 determines that there is an abnormality in input data and is provided with: a probability density calculator 11 that calculates, as an input density value, a probability density value for the input data in a probability density function constructed based on a data set; an occurrence probability calculator 12 that calculates, as an occurrence probability with respect to the input data, a value corresponding to an integral of the probability density function across a tail region in which the probability density value in the probability density function is equal to or less than the input density value; and an abnormality determiner 13 determines that there is an abnormality in the input data based on the occurrence probability.

This application is based on and claims the benefit of priority from Japanese Patent Application No. 2021-109172, filed on 30 Jun. 2021, the content of which is incorporated herein by reference.

### BACKGROUND OF THE INVENTION

### Field of the Invention

The present invention pertains to a data abnormality determination apparatus and an internal state prediction system. In more detail, the present invention pertains to a data abnormality determination apparatus that determines that there is an abnormality in input data, and an internal state prediction system provided with this data abnormality determination apparatus.

### Related Art

In the past, many proposals have been made for techniques for, in a state where a certain quantity of data sets have been acquired, determining that there is an abnormality in newly acquired data. For example, Patent Documents 1 and 2 describe techniques for determining abnormalities in data based on a Hotelling T² method.

Patent Document 1: Japanese Unexamined Patent Application, Publication No. 2020-131443

Patent Document 2: Japanese Unexamined Patent Application, Publication No. 2017-151593

### SUMMARY OF THE INVENTION

However, the Hotelling T² method has a premise that a data set conforms to a normal distribution. Accordingly, the Hotelling T² method cannot be applied in the case where a data set conforms to another distribution shape, for example a multimodal distribution shape.

The present invention has an objective of providing a data abnormality determination apparatus that can determine that there is an abnormality in data regardless of the distribution shape of a data set, and an internal state prediction system provided with this data abnormality determination apparatus.

(1) A data abnormality determination apparatus (for example, data abnormality determination apparatuses 1, 8 described below) according to the present invention is for determining that there is an abnormality in input data and includes: a probability density calculator (for example, probability density calculators 11, 81 described below) configured to calculate, as an input density value, a probability density value for the input data in a probability density function constructed based on a data set; an occurrence probability calculator (for example, occurrence probability calculators 12, 82 described below) configured to calculate, as an occurrence probability for the input data, a value corresponding to an integral, for the probability density function across a tail region in which a probability density value in the probability density function is equal to or less than the input density value; and an abnormality determiner (for example, abnormality determiners 13, 83 described below) configured to determine that there is an abnormality in the input data, based on the occurrence probability.

(2) In this case, it is desirable for the occurrence probability calculator to have calibration curve data that associates a probability density value in the probability density function with an integral of the probability density function across the tail region, and calculate, as the occurrence probability, an integral associated with the input density value by the calibration curve data.

(3) In this case, it is desirable for the occurrence probability calculator to calculate, as the occurrence probability, a ratio of the number of data points included in the tail region with respect to a total number of data points, from among a plurality of data points generated in accordance with the probability density function, based on a Monte Carlo method.

(4) An internal state prediction system (for example, an internal state prediction system 5 described below) according to the present invention predicts an internal state of a target object and includes: an input data obtainment apparatus (for example, an input data obtainment apparatus 6 described below) configured to obtain input data correlated to the internal state; a model prediction apparatus (for example, a model prediction apparatus 7 described below) configured to, based on the input data and a prediction model constructed based on a training data set, predict the internal state; a data abnormality determination apparatus (for example, a data abnormality determination apparatus 8 described below) configured to determine that there is an abnormality in the input data; and a reliability determination apparatus (for example, a reliability determination apparatus 9 described below) configured to, based on a determination result by the data abnormality determination apparatus, determine a reliability for a prediction result from the model prediction apparatus, in which the data abnormality determination apparatus includes a probability density calculator (for example, a probability density calculator 81 described below) configured to calculate, as an input density value, a probability density value for the input data in a probability density function constructed based on the training data set, an occurrence probability calculator (for example, an occurrence probability calculator 82 described below) configured to calculate, as an occurrence probability for the input data, a value corresponding to an integral for the probability density function across a tail region in which a probability density value in the probability density function is equal to or less than the input density value, and an abnormality determiner (for example, an abnormality determiner 83 described below) configured to determine that there is an abnormality in the input data, based on the occurrence probability.

(1) In the data abnormality determination apparatus according to the present invention, the probability density calculator calculates, as an input density value, a probability density value for input data in a probability density function constructed based on a data set, the occurrence probability calculator calculates, as an occurrence probability with respect to the input data, a value corresponding to an integral of the probability density function across a tail region in which the probability density value in the probability density function is equal to or less than the input density value, and the abnormality determiner determines that there is an abnormality in the input data based on the occurrence probability. By virtue of the present invention, it is possible to calculate the occurrence probability for the input data regardless of the number of dimensions for the data set and the shape of the probability density function, which is based on this data set, and it is also possible to appropriately determine that there is an abnormality in the input data.

(2) In the data abnormality determination apparatus according to the present invention, the occurrence probability calculator has calibration curve data that associates a probability density value in the probability density function with an integral of the probability density function across the tali region, and calculates, as the occurrence probability, an integral associated with the input density value by the calibration curve data. By virtue of the present invention, it is possible to quietly determine that there is an abnormality in input data.

(3) There is typically a tendency for creation of calibration curve data as described above to take more time the greater the number of dimensions in the data set. In contrast to this, in the data abnormality determination apparatus according to the present invention, the occurrence probability calculator calculates, as the occurrence probability, the ratio of the number of data points included in the tail region with respect to the total number of data points, from among a plurality of data points generated in accordance with the probability density function, based on a Monte Carlo method. Accordingly, by virtue of the present invention, in particular implementation becomes easy in a case where there is a large number of dimensions for a data set.

(4) In the internal state prediction system according to the present invention, the model prediction apparatus, based on input, data obtained by the input data obtainment apparatus and a prediction model constructed based on a training data set, predicts an internal state for a target object. Here, in a case where the input data deviates from the training data set used when the prediction model was constructed, a prediction result by the model prediction apparatus based on such input, data can be considered to have low reliability. In response to this, in the internal state prediction system according to the present invention, the data abnormality determination apparatus determines that there is an abnormality in the input data based on a probability density function constructed based on a training data set, and the reliability determination apparatus, based on a determination result by the data abnormality determination apparatus, determines a reliability for the prediction result by the model prediction apparatus. As a result, it is possible to guarantee the reliability of a prediction result produced by the model prediction apparatus regarding the internal state.

### BRIEF DESCRIPTION OF THE DRAWINGS

FIG. 1 is a functional block diagram that illustrates a configuration of a data abnormality determination apparatus according to a first embodiment of the present invention;

FIG. 2A is a view that illustrates an example of a two-dimensional data set used when constructing a probability density function;

FIG. 2B is a view that illustrates an example of a probability density function constructed based on the data set illustrated in FIG. 2A;

FIG. 3 is a view for describing a procedure for, in an occurrence probability calculator, calculating an occurrence probability for input data;

FIG. 4 is a view that illustrates an example of calibration curve data; and

FIG. 5 is a functional block diagram that illustrates a configuration of an internal state prediction system according to a second embodiment of the present invention.

### DETAILED DESCRIPTION OF THE INVENTION

### First Embodiment

With reference to the drawings, description is given below regarding a data abnormality determination apparatus according to a first embodiment of the present invention.

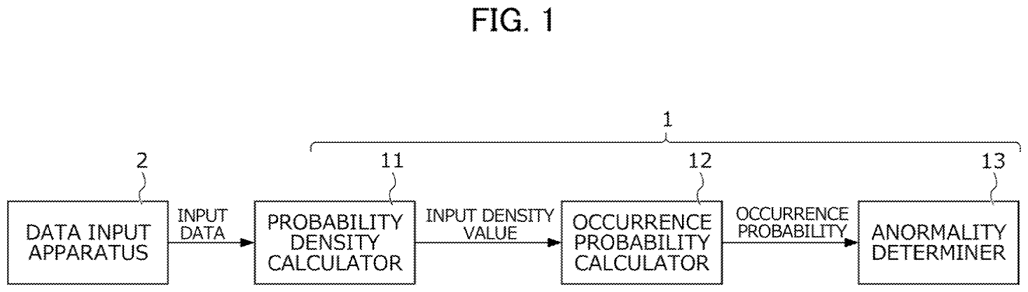

FIG. 1 is a functional block diagram that illustrates a configuration of a data abnormality determination apparatus 1 according to the present embodiment. The data abnormality determination apparatus 1 uses a probability density function constructed based on a set of N-dimensional data (N is an integer equal to or greater than 1) to thereby determine that there is an abnormality in N-dimensional input data newly inputted from a data input apparatus 2.

Description is given below regarding a case where the number of dimensions N for data handled in the data abnormality determination apparatus 1 is set to 2, in other words a case where the data abnormality determination apparatus 1 handles two-dimensional data, but the present invention is not limited to this. Data handled in the data abnormality determination apparatus 1 may be one-dimensional or may be multi-dimensional and have three or more dimensions.

The data abnormality determination apparatus 1 is a computer configured by hardware including an arithmetic processing means such as a CPU, an auxiliary storage means such as an HDD or an SSD that stores various programs, and a main storage means such as a RAM that stores data which is temporarily necessary for the arithmetic processing means to execute a program. By such a hardware configuration, various functionality such as a probability density calculator 11, an occurrence probability calculator 12, and an abnormality determiner 13 are realized in the data abnormality determination apparatus 1.

The probability density calculator 11 has a probability density function constructed using, for example, kernel density estimation based on an N-dimensional data set collected in advance. When newly inputted with N-dimensiona1 input data from the data input apparatus 2, the probability density calculator 11 calculates, as an input density value, a probability density value for the input data in the probability density function, and outputs the input density value to the occurrence probability calculator 12. Note that a probability density function referred to below is assumed to be normalized so that an integral for the probability density function across the entire domain for a random variable (in other words, input data) becomes “1”.

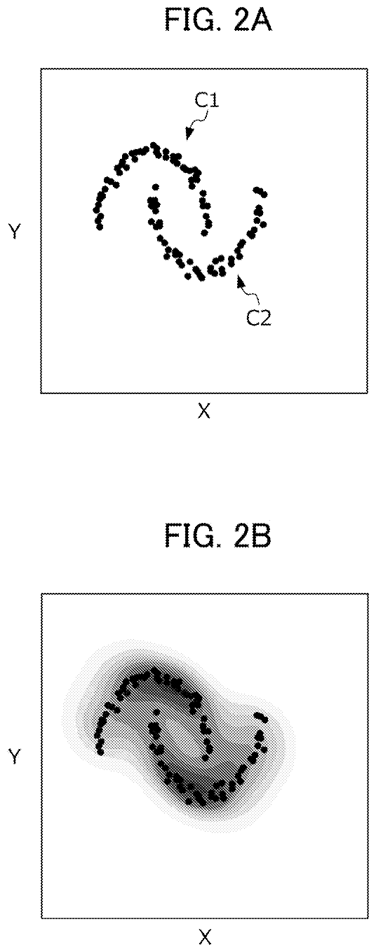

FIG. 2A is a view that illustrates an example of a data set for two-dimensional data (X, Y) used when constructing a probability density function. FIG. 2B is a view that illustrates an example of a probability density function constructed based on the data set illustrated in FIG. 2A. Note that, in FIG. 2B, the probability density function is a function of two variables, and the height of the function, in other words the magnitude of the probability density values, is represented by shading.

The data set exemplified in FIG. 2A includes a first cluster C1 that constitutes a plurality of items of data concentratedly distributed in an arc shape that protrudes upward in FIG. 2A, and a second cluster C2 that constitutes a plurality of items of data concenlratedly distributed in an arc shape that protrudes downward in FIG. 2A. In this manner, a probability density function construct based on the data set that includes the plurality of clusters C1 and C2 becomes multimodal as exemplified in FIG. 2B.

Based on the input density value for the input data and the probability density function referred to when the input density value was calculated in the probability density calculator 11, the occurrence probability calculator 12 calculates an occurrence probability [%] with respect to the input data, and outputs the occurrence probability to the abnormality determiner 13.

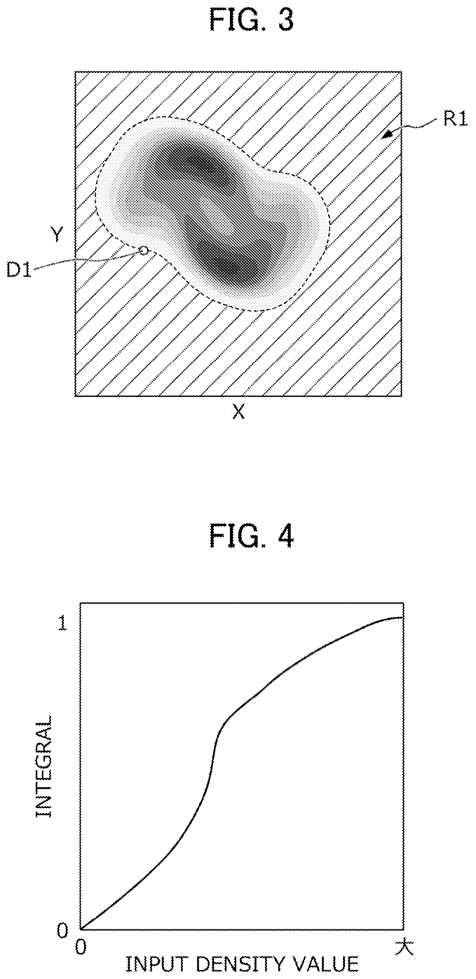

FIG. 3 is a view for describing a procedure for, in the occurrence probability calculator 12, calculating an occurrence probability for input data D1. The occurrence probability calculator 12 defines a tail region R1 (region indicated by hatching in FIG. 3) to be a region in which a probability density value in the probability density function becomes less than or equal to the input density value calculated for the input data D1. The occurrence probability calculator 12 also calculates, as an occurrence probability for the input data D1, a value corresponding to an integral for the probability density function across the entire tail region R1. Description is given below for a first example and a second example of a specific procedure for calculating a value corresponding to the integral of the probability density function across the tail region as above.

### FIRST EXAMPLE

As described with reference to FIG. 3, the tail region R1 is uniquely defined for each input density value. In other words, as long as the input density value does not change, the tail region R1 is constant regardless of a position in the input data D1. Accordingly, because the integral across the tail region R1 for the probability density function is also uniquely defined for each input density value, it is possible to use calibration curve data to associate the input density value with the integral across the tail region R1 for the probability density function. Accordingly, in the first example, by calculating an integral for the probability density function across a tail region defined for each probability density value, calibration curve data (refer to FIG. 4) that associates the input density value with the integral (in other words, a cumulative probability) is created in advance. More specifically, it is possible to create the calibration curve data by, for example, creating a plurality of contours (in other words, lines on the probability density function that are defined by a plurality of items of input data having the same probability density value) on the probability density function and calculating integrals of the probability density function across tail regions demarcated by these contours. In accordance with a procedure such as the above, the occurrence probability calculator 12 uses calibration curve data created in advance to calculate, as the occurrence probability, an integral associated with an input density value.

### SECOND EXAMPLE

In the second example, an integral of a probability density function across a tail region as described above is calculated based on a Monte Carlo method. In other words, from among a plurality of data points randomly generated in accordance with the probability density function, the ratio of a number of data points included in the taxi region with respect to the total number of data points is approximately equal to an integral for the probability density function across the tail region. Accordingly, in the second example, the occurrence probability calculator 12 calculates, as the occurrence probability, the ratio of the number of data points included in the tail region with respect to the total number of data points, from among a plurality of data points generated in accordance with the probability density function, based on the Monte Carlo method. Note that, in the second example, based on the Monte Carlo method as described above, it is also possible to map in advance a relationship between a derived input density value and the occurrence probability. In this case, the occurrence probability calculator 12 uses an input density value to search a map as described above to thereby be able to quickly calculate an occurrence probability that corresponds to the input density value.

Based on the occurrence probability calculated by the occurrence probability calculator 12, the abnormality determiner 13 determines that there is an abnormality in input data. More specifically, in a case where the occurrence probability is less than a predefined abnormality determination threshold (for example, a few percent), the abnormality determiner 13 determines that the input data has an abnormality. In a case where the occurrence probability is equal to or greater than the abnormality determination threshold, the abnormality determiner 13 determines that the input data is normal.

By virtue of the data abnormality determination apparatus 1 according to the present embodiment, the following effects are achieved.

(1) In the data abnormality determination apparatus 1, the probability density calculator 11 calculates, as an input density value, a probability density value for input data in a probability density function constructed based on a data set, the occurrence probability calculator 12 calculates, as an occurrence probability with respect to the input data, a value corresponding to an integral of the probability density function across a tail region in which the probability density value in the probability density function is equal to or less than the input density value, and the abnormality determiner 13 determines that there is an abnormality in the input data based on the occurrence probability. By virtue of the data abnormality determination apparatus 1, it is possible to calculate the occurrence probability for the input data regardless of the number of dimensions for the data set and the shape of the probability density function, which is based on this data set, and it is also possible to appropriately determine that there is an abnormality in the input data.

(2) The occurrence probability calculator 12 in the first example has calibration curve data that associates a probability density value in the probability density function with an integral of the probability density function across the tail region, and calculates, as the occurrence probability, an integral associated with the input density value by the calibration curve data. By virtue of the data abnormality determination apparatus 1, it is possible to quickly determine that there is an abnormality in input data.

(3) There is typically a tendency for creation of the calibration curve data in the first example described above to take more time the greater the number of dimensions in a data set. In contrast to this, the occurrence probability calculator 12 in the second example calculates, as the occurrence probability, the ratio of the number of data points included in the tail region with respect to the total number of data points, from among a plurality of data points generated in accordance with the probability density function, based on a Monte Carlo method. Accordingly, by virtue of the data abnormality determination apparatus 1. In particular Implementation becomes easier in the case where there is a large number of dimensions in a data set.

### Second Embodiment

Next, with reference to the drawings, description is given regarding an internal state prediction system according to a second embodiment of the present invention.

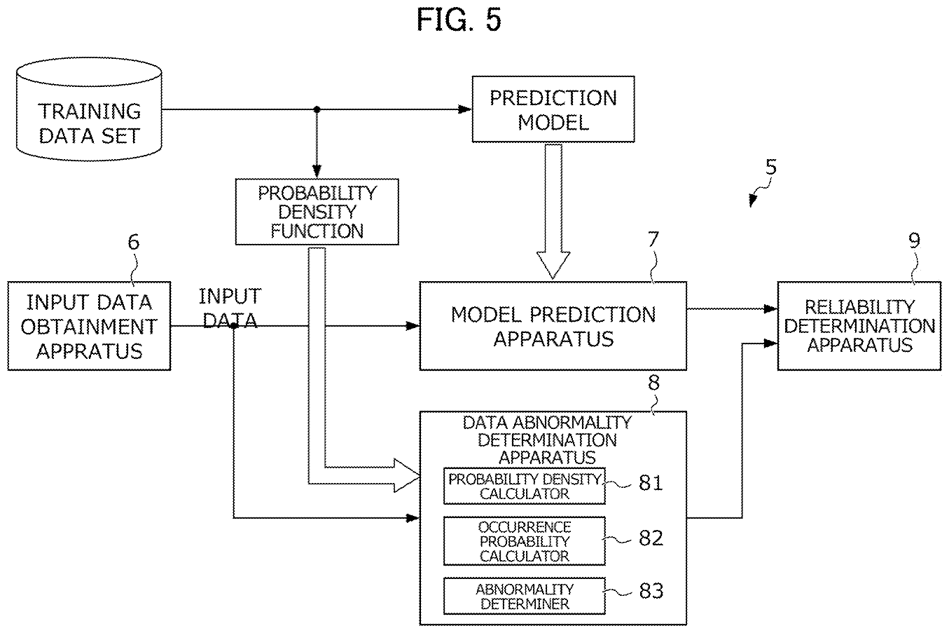

FIG. 5 is a functional block diagram that illustrates a configuration of an internal state prediction system 5 according to the present embodiment. The internal state prediction system 5 is, for example, mounted in an electric vehicle (not illustrated) that travels using electric power supplied from a battery, and predicts an internal state (for example, a future deteriorated state) for the battery in the traveling electric vehicle.

The internal state prediction system 5 is a computer configured by hardware including an arithmetic processing means such as a CPU, an auxiliary storage means such as a HDD or an SSD that stores various programs, and a main storage means such as a RAM that stores data temporarily necessary for the arithmetic processing means to execute a program. By such a hardware configuration, various functionality such as an input data obtainment apparatus 6, a model prediction apparatus 7, a data abnormality determination apparatus 3, and a reliability determination apparatus 9 are realized in the internal state prediction system 5.

The input data obtainment apparatus 6 obtains M-dimensional (M is an integer equal to or greater than 1) input data correlated with a future deteriorated state of a battery, which is a target object for a prediction by the internal state prediction system 5, and transmits the M-dimensional input data to the model prediction apparatus 7 and the data abnormality determination apparatus 8. Here, the input data correlated with the future deteriorated state of the battery is, for example, a temperature history, current history, and voltage history for the battery.

The model prediction apparatus 7 is provided with a prediction model that has been constructed based on an M-dimensional training data set using a known learning algorithm so that the prediction model, when inputted with M-dimensional input data, outputs a prediction value for a future deteriorated state for the battery. When new input data is transmitted from the input data obtainment apparatus 6, the model prediction apparatus 7 inputs this input data to the prediction model to thereby predict a future deteriorated state for the battery.

With a configuration that is approximately the same as that of the data abnormality determination apparatus 1 according to the first embodiment, the data abnormality determination apparatus 8 determines that there is an abnormality in new input data transmitted from the input data obtainment apparatus 6. More specifically, the data abnormality determination apparatus 8 is provided with: a probability density calculator 81 that calculates, as an input density value, a probability density value for input data in a probability density function constructed based on the same training data set used when constructing the prediction model described above; an occurrence probability calculator 82 that calculates, as an occurrence probability with respect to the input data, a value corresponding to an integral of the probability density function across a tail region in which the probability density value in the probability density function is equal to or less than the input density value; and an abnormality determiner 83 that determines that there is an abnormality in the input data based on the occurrence probability. Note that, except for configurations of input data and data sets and the configuration of the probability density function, the configurations of the probability density calculator 81, the occurrence probability calculator 82, and the abnormality determiner 83 are respectively approximately the same as the configurations of the probability density calculator 11, the occurrence probability calculator 12, and the abnormality determiner 13 according to the first embodiment, and detailed description is omitted.

Based on a determination result by the data abnormality determination apparatus 8 pertaining to an abnormality in input data newly obtained by the input data obtainment apparatus 6, the reliability determination apparatus 9 determines a reliability for a prediction result from the model prediction apparatus 7 that is based on the same input data. More specifically, the reliability determination apparatus 9 determines that the reliability of a prediction result from the model prediction apparatus 7 is low in a case where the data abnormality determination apparatus 8 has determined that there is an abnormality in input data newly obtained by the input data obtainment apparatus 6, and determines that the reliability of a prediction result from the model prediction apparatus 7 is high in a case where the data abnormality determination apparatus 8 has determined that the input data is normal.

By virtue of the internal state prediction system 5 according to the present embodiment, the following effect is achieved.

(4) In the internal state prediction system 5, the model prediction apparatus 7, based on input data obtained by the input data obtainment apparatus 6 and a prediction model constructed based on a training data set, predicts a future deteriorated state of a battery. Here, in a case where the input data deviates from the training data set used when the prediction model was constructed, a prediction result by the model prediction apparatus 7 based on such input data can be considered to have, low reliability. In response to this, in the internal state prediction system 5, the data abnormality determination apparatus 3 determines that there is an abnormality in the input data based on a probability density function constructed based on a training data set, and the reliability determination apparatus 9, based on a determination result by the data abnormality determination apparatus 3, determines a reliability for the prediction result by the model prediction apparatus 7. As a result, it is possible to guarantee the reliability of a prediction result produced by the model prediction apparatus 7 regarding the future deteriorated state for a battery.

Description was given above regarding embodiments of the present invention, but the present invention is not limited to this. The detailed configurations may be changed, as appropriate, within the scope of the gist of the present invention.

What is claimed is:

1. A data abnormality determination apparatus for determining that there is an abnormality in input; data, comprising:
a probability density calculator configured to calculate, as an input density value, a probability density value for the input data in a probability density function constructed based on a data set;
an occurrence probability calculator configured to calculate, as an occurrence probability for the input data, a value corresponding to an integral for the probability density function across a tail region in which a probability density value in the probability density function is equal to or less than the input, density value; and
an abnormality determiner configured to determine that there is an abnormality in the input data, based on the occurrence probability.

2. The data abnormality determination apparatus according to claim 1, wherein the occurrence probability calculator has calibration curve data that associates a probability density value in the probability density function with an integral of the probability density function across the tail region, and calculates, as the occurrence probability, an integral associated with the input density value by the calibration curve data.

3. The data abnormality determination apparatus according to claim 1, wherein the occurrence probability calculator calculates, as the occurrence probability, a ratio of a number of data points included in the tail region with respect to a total number of data points from among a plurality of data points generated in accordance with the probability density function, based on a Monte Carlo method.

4. An internal state prediction system for predicting an internal state of a target object, comprising:
an input data obtainment apparatus configured to obtain input data correlated to the internal state;
a model prediction apparatus configured to, based on the input data and a prediction model constructed based on a training data set, predict the internal state;
a data abnormality determination apparatus configured to determine that there is an abnormality in the input data; and
a reliability determination apparatus configured to, based on a determination result by the data abnormality determination apparatus, determine a reliability for a prediction result from the model prediction apparatus,
wherein the data abnormality determination apparatus includes
a probability density calculator configured to calculate, as an input density value, a probability density value for the input data in a probability density function constructed based on the training data set,
an occurrence probability calculator configured to calculate, as an occurrence probability for the input data, a value corresponding to an integral for the probability density function across a tail region in which a probability density value in the probability density function is equal to or less than the input density value, and
an abnormality determiner configured to determine that there is an abnormality in the input data, based on the occurrence probability.
